(19) United States
(12) Patent Application Publication
(10) Pub. No.: US 2026/0129569 A1
(43) Pub. Date: May 7, 2026

(54) READER DEVICE MANAGEMENT FOR AMBIENT INTERNET OF THINGS (IOT) SERVICES

(71) Applicant: Interdigital Patent Holdings, Inc., Wilmington, DE (US)

(72) Inventors: Guanzhou Wang, Brossard (CA); Michael Starsinic, Newtown, PA (US); Anuj Sethi, Ottawa (CA); Mohamad Kenan AI-Hares, Canterbury (GB); Samir Ferdi, Kirkland (CA); Ulises Olvera-Hernandez, Saint-Lazare (CA)

(73) Assignee: Interdigital Patent Holdings, Inc., Wilmington, DE (US)

(21) Appl. No.: 18/940,320

(22) Filed: Nov. 7, 2024

(51) Int. Cl. H04W 48/20; H04W 64/00; H04W 76/20; H04W 76/30

(52) U.S. Cl. CPC H04W 48/20; H04W 64/00; H04W 76/20; H04W 76/30

(57) ABSTRACT

A network node receives a first service request, which includes service pattern information and a second service request. Further, the network node selects a wireless transmit/receive unit (WTRU) reader from among one or more candidate WTRUs. Also, the network node determines a WTRU state management strategy based on the service pattern information and the second service request. Further, the network node transmits, to the selected WTRU reader, a third service request in a first radio resource control (RRC) message. Moreover, the third service request is an ambient-power-enabled Internet of Things (IoT) (AIoT) service request and includes the second service request. Further, the network node receives, from the selected WTRU reader, an AIoT service response in a second RRC message. Additionally or alternatively, the network node may forward the received AIoT service response to an AIoT function (AIoTF) node. Further, the first service request is received from the AIoTF node.

### BACKGROUND

An ambient-power-enabled Internet of Things (IoT) (AIoT) device, is a kind of IoT device that can harvest energy from the environment, such as wireless radio waves, motion, vibration, piezoelectricity, solar power, wind power, and so forth. AIoT devices are typically either battery-less or have limited energy storage, such as by using a capacitor. AIoT devices often find their usage in Industrial Wireless Senor Networks where the environment is harsh (e.g., extremely high or low temperature) and requires devices to be battery-less and maintenance-free, and have a long service life. They will also play an important role in Smart Logistics and Smart Warehousing.

Their low-cost, small-form, battery-lessness and durability make AIoT devices suitable to be attached to a huge number of goods and facilitate more efficient identifying, sorting, tracking and inventory of goods. In 3^{rd} Generation Partnership Project (3GPP) wireless communication, a device that tis capable of communicating with AIoT devices over a radio interface is called a reader or AIoT reader.

### SUMMARY

Disclosed herein are apparatus and methods for wireless transmit/receive unit (WTRU) reader management by a base station node for ambient-power-enabled Internet of Things (IoT) (AIoT) services. In an example, a network node receives a first service request, which includes service pattern information and a second service request. Further, the network node selects a WTRU reader from among one or more candidate WTRUs. Also, the network node determines a WTRU state management strategy based on the service pattern information and the second service request. Further, the network node transmits, to the selected WTRU reader, a third service request in a first radio resource control (RRC) message. Moreover, the third service request is an AIoT service request and includes the second service request. Further, the network node receives, from the selected WTRU reader, an AIoT service response in a second RRC message.

Additionally or alternatively, the network node may forward the received AIoT service response to an AIoT function (AIoTF) node. Further, the first service request is received from the AIoTF node. Additionally or alternatively, the network node may transmit, based on the determined WTRU state management strategy, a first RRC release message to the selected WTRU reader.

Additionally or alternatively, the network node may transmit, based on the determined WTRU state management strategy, a second RRC release message to the selected WTRU reader. Additionally or alternatively, the second RRC release message includes configuration information for entering an RRC_Inactive state.

Additionally or alternatively, the first service request is received in an N2 message. Additionally or alternatively, the second service request is an AIoT service request originating at an AIoT application function (AF). Additionally or alternatively, the AIoT service request originating at the AIoT AF includes one or more of: a target AIoT device identifier, an AIoT service type, and a target area.

Additionally or alternatively, the WTRU reader is selected based on location information of the one or more candidate WTRUs. Additionally or alternatively, the location information is determined based on an AIML-based positioning calculation using collected positioning measurements of the one or more candidate WTRUs.

Additionally or alternatively, the WTRU reader is selected based on a mobility state of the one or more candidate WTRUs. Additionally or alternatively, the first service request includes a list of the one or more candidate WTRUs, and a target area.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a topology diagram illustrating example topologies for ambient-power-enabled Internet of Things (IoT) (AIoT) service support in a Fifth Generation (5G) network;

FIG. 3 is a signaling diagram illustrating an example of WTRU reader statement management using AIoT service pattern information;

FIG. 4 is a flowchart diagram illustrating an example of a WTRU communication with an AIoT device concerning AIoT service;

FIG. 5 is a flowchart diagram illustrating an example of how a next generation (NG)-radio access network (RAN) node uses service pattern information;

FIG. 6 is a signaling diagram illustrating an example of an AIoT service abort due to a not reachable WTRU reader; and

FIG. 7 is a signaling diagram illustrating an example of an AIoT service specific area configuration and usage.

### DETAILED DESCRIPTION

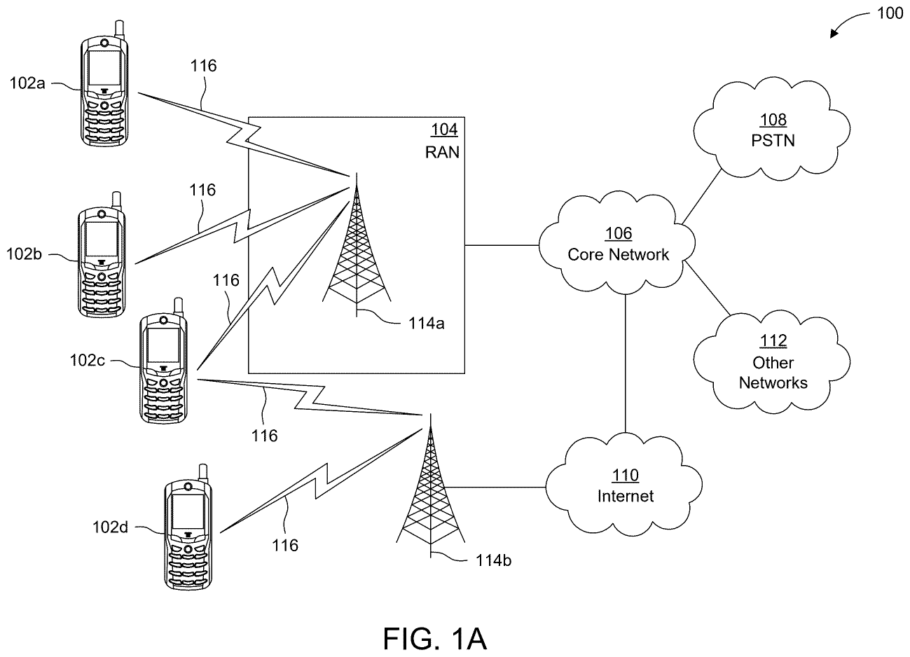

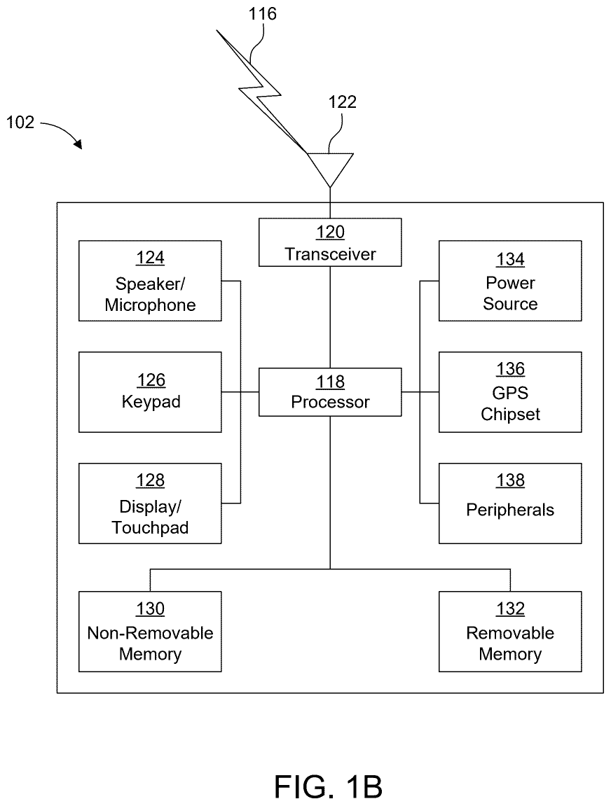

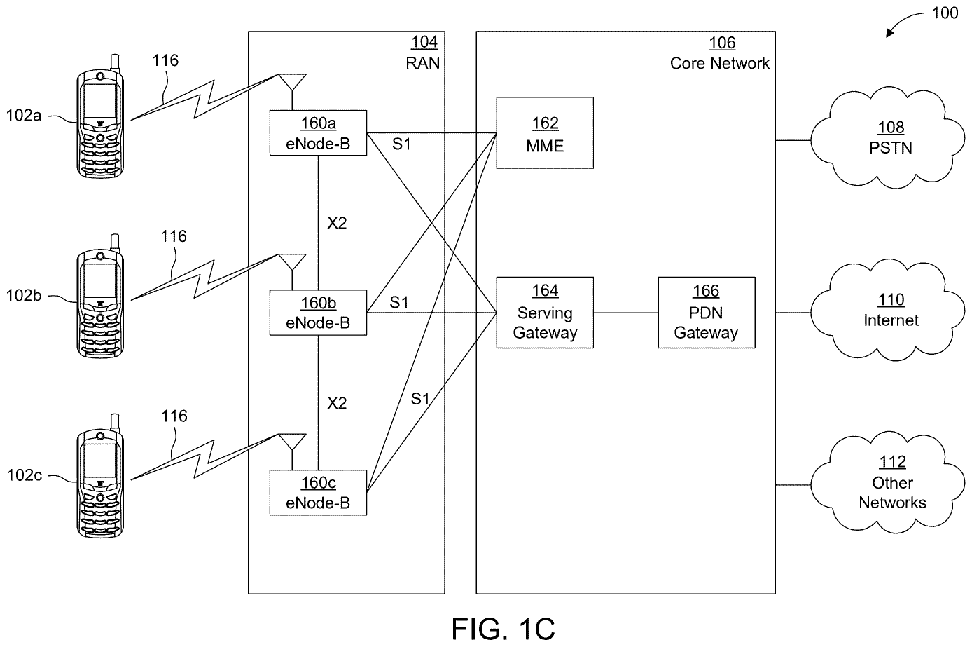

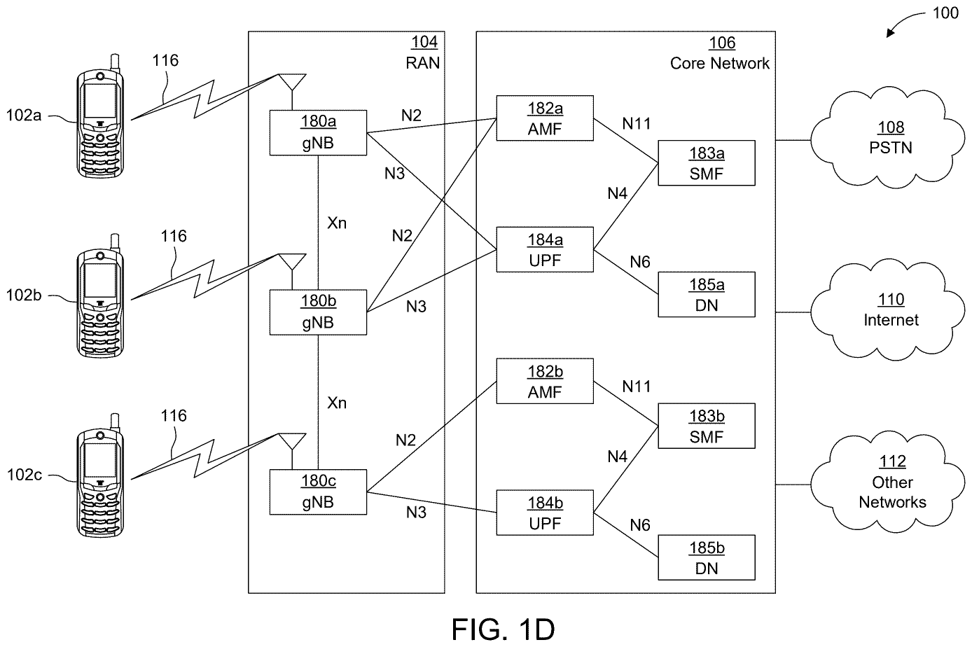

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3^{rd} Generation Partnership Project (3GPP) access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In recent 3GPP work, a WTRU or RAN node, such as a base station or gNB, that is capable of communicating with ambient-power-enabled IoT (AIoT) devices over a radio interface is called a Reader or AIoT Reader. A WTRU that serves as a Reader is called a WTRU Reader, a UE that serves as a Reader is called a “UE Reader,” and a RAN node that serves as a Reader is called BS Reader or AIoT capable RAN Node in this work. It is also proposed that a new Network Function (NF), an AIoT Function or AIoT Controller, may be introduced to handle AIoT services. The AIoT Function may be collocated in other NFs such as an AMF. A current study focuses on two use cases, namely Inventory and Command. Basically, in the Inventory procedure, the AIoT Application Server collects some simple information such as device identification from the AIoT devices through the Fifth Generation Core (5GC) and the readers. in the Command procedure, the AIoT Application Server sends one or more simple command messages, e.g., “Read/Write” or “Disable”, to the AIoT devices through the 5GC and the readers.

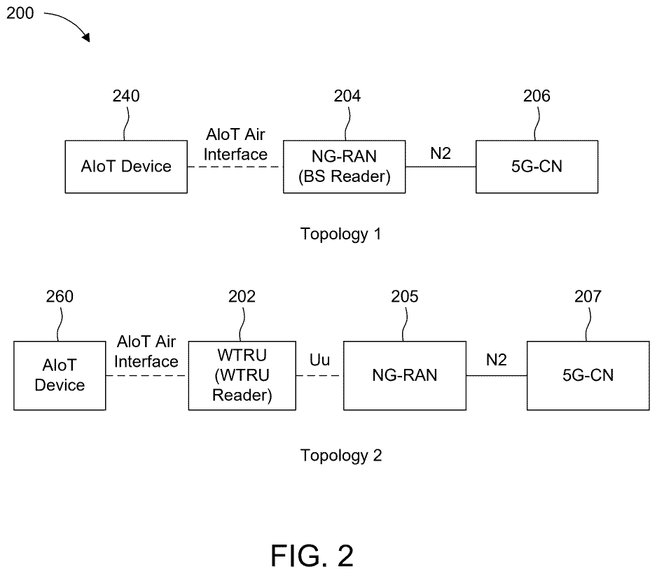

FIG. 2 is a topology diagram illustrating example topologies for AIoT service support in a Fifth Generation (5G) network. As shown in topology diagram 200, two architecture options for AIoT services, namely Topology 1 and Topology 2, are supported by the 5G network. In Topology 1, AIoT devices, such as AIoT device 240, are able to communicate directly with the 5G core network 206, e.g., via BS Reader or AIoT capable RAN node 204. In Topology 2, AIoT devices 260 communicate indirectly with the 5G core network 207 and a next generation (NG)-RAN node 205 via an Intermediate Node, for example, a WTRU Reader 202. The AIoT air interface is supposed to be the same for both Topology 1 and Topology 2. In an example, WTRU Reader 202 is the same as or similar to WTRU 102.

In a typical AIoT service procedure (e.g., Inventory procedure), the WTRU Reader is supposed to be in a Connected mode so it can receive AIoT service requests (e.g., Inventory Request) from the serving NG-RAN (e.g., gNB), and may remain in Connected mode until the NG-RAN indicates it to enter an IDLE mode or RRC_Inactive mode. In case that the ongoing AIoT service request is an occasional event and no subsequent AIoT service requests need to be handled by the WTRU Reader, the WTRU should be released to the IDLE mode or RRC_Inactive mode once the ongoing AIoT service procedure is over, to save the WTRU's battery. However, if there are one or more subsequent AIoT service requests to be handled by the WTRU, the WTRU should remain in Connected mode to avoid being frequently brought from IDLE to Connected mode. Therefore, the NG-RAN needs to make a proper decision that suits the AIoT service pattern concerning whether to keep the WTRU Reader in Connected mode or to indicate to the WTRU to switch to other modes (IDLE or RRC_Inactive).

Further, when the AIoTF or AMF selects an NG-RAN to handle the AIoT service request, it chooses the NG-RAN that currently serves one or more selected candidate WTRU Readers and sends one or more AIoT service requests to the selected NG-RAN. However, while the candidate WTRU Reader is in RRC_Inactive mode, it may roam to other areas that are served by other NG-RANs. When this WTRU Reader is paged by the selected NG-RAN and resumes operating in Connected mode, it may be Connected to another NG-RAN that is different from the one that receives the one or more AIoT service requests. Simply forwarding the AIoT service requests to the NG-RAN that the candidate WTRU Reader is currently connected to may not work, as the WTRU Reader is not at the intended location anymore and may not be able to reach the target AIoT devices. This situation needs to be properly handled so that the AIoT service request can be successfully handled.

Examples and embodiments provided herein include AIoT service pattern information for an NG-RAN node to manage a WTRU Reader state. When an AIoT function (AIoTF) receives an AIoT service request (e.g., Inventory Request) from the an AIoT application function (AF) or Application Server, the service request may contain or be accompanied by service pattern information. The service pattern information may indicate the following information.

For example, the service pattern information may include whether the current request is followed by one or more subsequent service requests. Also, the service pattern information may include a number of the subsequent service requests. In addition, the service pattern information may include whether the subsequent service requests are periodical, and the frequency of the periodical service requests (e.g., once per minute). Moreover, the service pattern information may include the total duration of the ongoing burst of service requests (e.g., estimated end time of the current burst of service requests).

The 5G core network may also produce AIoT service pattern analytics based on statistics of the AIoT service requests received by the 5G CN from various AIoT service providers. For example, the network data analytics function (NWDAF) in the 5G CN may collect statistics of the incoming AIoT service requests from the network exposure function (NEF) or AIoTFs. The statistics may include the source address of the incoming AIoT service requests, the identifier of the AIoT service that the incoming requests are associated with, and a number of AIoT service requests that are received consecutively (e.g., two requests are considered consecutively received if the time between two requests is less than 10 seconds). These consecutive requests can be considered as a burst of service requests. The statistics may also include the frequency of the consecutive requests (e.g., number of requests per second), busy-hour of the AIoT service (e.g., time period of the day during which the most requests are received), average time between two service request bursts, and so forth. Based on these statistics, the NWDAF may produce analytics of a service pattern for various AIoT services.

The analytics may give a prediction on characteristics of an ongoing burst of AIoT service requests and future subsequent AIoT requests. The NWDAF may also provide the analytics exposure services to service customers outside the 5G CN, e.g., the AIoT AF, so the AIoT AF may obtain the service pattern information using NWDAF analytics services and provide the service pattern information when it sends requests to the 5G CN.

If the AIoTF has “service pattern information” available, either received from the AIoT service provider or from the NWDAF, the AIoTF may send the service pattern information to the selected NG-RAN, along with the AIoT service request which will be handled by the NG-RAN. The AIoTF may also provide information for one or a list of candidate WTRU Readers (e.g., WTRU Reader identifies, mobility state (stationary or moving), etc.) along with the AIoT service request to the NG-RAN. The AIoTF may have determined the candidate WTRU Reader information based on a target area received from the AIoT service provider and the WTRU Reader locations (i.e. the WTRU Reader should be close to the target area, so the WTRU Reader is able to reach target AIoT devices). The AIoTF may also provide the target area information to the NG-RAN.

If the AIoTF does not provide a WTRU Reader identity, or provides multiple WTRU Reader identities, the NG-RAN may perform its own WTRU Reader selection or down-selection based on the following criteria or information.

The information may include whether the WTRU was authorized to perform Reader functionalities and serve the application which has sent the AIoT service request. This information may be stored in the WTRU context that the NG-RAN maintains.

Additionally or alternatively, the information may include whether the WTRU location should be in or close to the target area. If the NG-RAN supports artificial intelligence machine learning (AIML)-based positioning, it may collect positioning measurements from the candidate WTRUs and use the AIML model to calculate the candidate WTRUs' current location and select the one that's mostly likely to service the target area. It may also determine whether the candidate WTRU is moving or stationary and may choose stationary WTRU Readers over moving ones.

Additionally or alternatively, the information may include whether the candidate WTRU Reader supports the radio resource (e.g. frequency spectrum) that the NG-RAN intend to use/assign for the current AIoT service request.

Additionally or alternatively, the information may include whether the available information of the candidate WTRU reader, such as power level or roaming capabilities, match the requirements of the serving applications. This information might be available in the AIoTF.

The NG-RAN may determine the duration of time that the selected WTRU reader can stay in the connected Mode before moving to RRC_Inactive mode or IDLE Mode based on the service pattern information associated with the ongoing AIoT service request and the content of the AIoT service request. For example, if the service pattern information indicates that there is no subsequent request or the subsequent request will happen long after the ongoing request, the NG-RAN may immediately release the WTRU Reader to IDLE after the ongoing AIoT service procedure is completed (e.g., after receiving the AIoT service response from the WTRU reader), or release the WTRU Reader to IDLE after a short period of time.

For example, if the service pattern information indicates there will be periodical subsequent requests, but the frequency of the periodical requests is low (e.g., once per 15 minutes), the NG-RAN may send the WTRU Reader to RRC_Inactive state. Otherwise, if the frequency is high (e.g., once per second), the NG-RAN may keep the WTRU Reader in Connected mode.

For example, if the service pattern information indicates that there is a burst of service requests, for example, a large amount of service requests will occur in a very short period of time, the NG-RAN will keep the WTRU Reader in Connected mode until the current burst of AIoT service requests is over.

The NG-RAN may also be able to inspect the content of the AIoT service request and obtain the following information. For example, the NG-RAN may obtain the AIoT service type, e.g., whether it's an Inventory request or a data (e.g., sensor data) reading request. A different service type may imply a different time needed for the WTRU Reader to complete the service procedure. For example, an inventory request may require relatively less time than a data reading request.

Additionally or alternatively, the NG-RAN may obtain information regarding whether the target AIoT device is a single device, multiple devices or a group of devices. A single target device will require less time than multiple devices or a group of devices for the WTRU Reader to complete the service procedure.

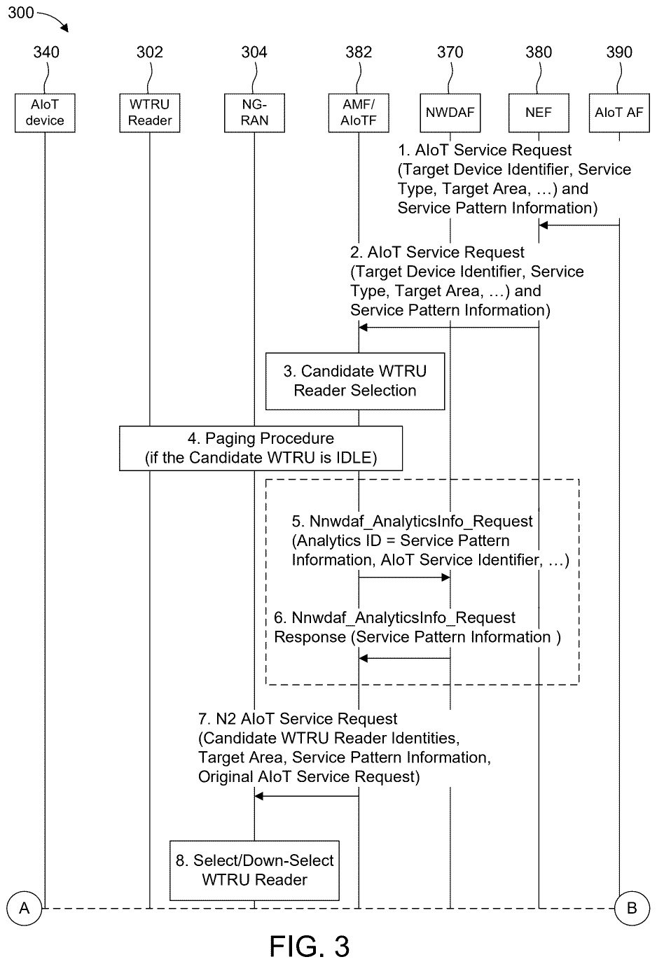

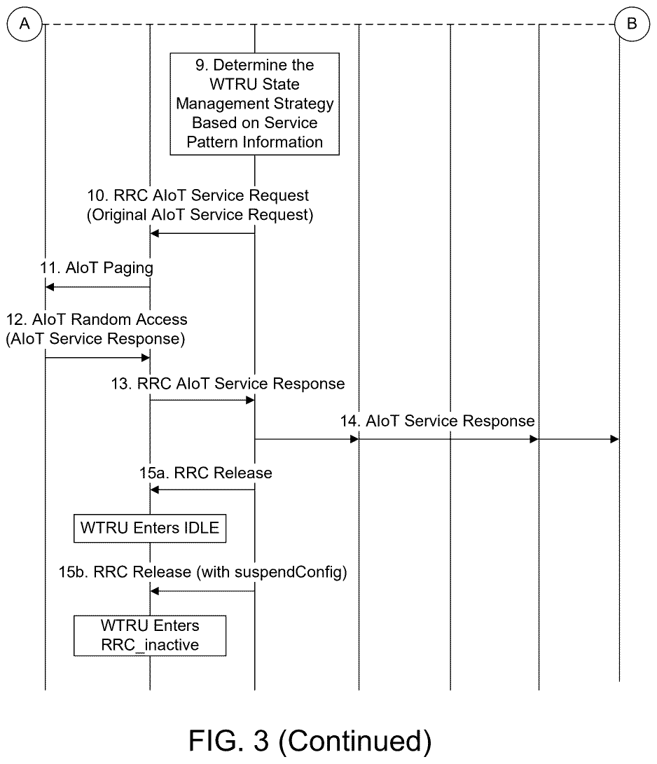

FIG. 3 is a signaling diagram illustrating an example of WTRU reader statement management using AIoT service pattern information. As shown in signaling diagram 300, the AIoT AF 390 or AIoT service provider sends an AIoT Service Request to the 5G CN via NEF 380, such as at step 1. The AIoT Service Request includes one or more target AIoT device identifiers, a target area where the target device is (or devices are), an AIoT service type (Inventory or Read/Write data, etc.) and other information. The AIoT AF 390 may also provide service pattern information, which describes the characteristics of the traffic of subsequent requests, together with the AIoT Service Request.

At step 2, the NEF 380 may authorize the incoming AIoT service request and select an AIoTF that should handle the request. In an example, the service area of the selected AIoTF 382 covers the target area of the AIoT service request. The NEF 380 then forwards the AIoT service request to the selected AIoTF 382. In an example, the NEF 380 may send the request to NWDAF 370, which then forwards the AIoT service request to the selected AIoTF 382. Further, AIoTF 382 may be part of or co-located with an AMF. In an example, AMF/AIoTF 382 may be the same as or similar to AMF 182a or AMF 182b. Additionally or alternatively, the AIoTF may be separate from but operatively coupled to the AMF.

At step 3, the AIoTF 382 determines one or multiple candidate WTRU Reader(s) based on the WTRU Reader information (WTRU Reader identity, WTRU Reader location, supported services of the WTRU Reader, etc.) it possesses and the content of the AIoT service request. For example, those WTRU Readers that are authorized to serve the AIoT service provider and are in the target area may be selected. Note that the WTRU Reader location that the AIoTF 382 possesses may not be the WTRU Reader's current location as the WTRU may move without notifying the CN (i.e. without sending a Registration Update).

At step 4, if the candidate WTRU is in IDLE mode, the AIoTF 382 may initiate a paging (via one or more AMFs) procedure to bring the candidate WTRUs to Connected mode. And once the candidate WTRU is in Connected mode, a current location of the candidate WTRU is reported to the AMF/AIoTF 382; and the AIoTF 382 may adjust its list of candidate WTRU Readers, e.g., move some WTRUs out of the list if their current location is not in the target area or if they did not respond to the paging. Additionally or alternatively, the paging procedure may include an NG-RAN node 304. In an example, the NG-RAN node 304 may be a gNB. Additionally or alternatively, the paging procedure may include a WTRU reader 302. In an example, the WTRU reader 302 may be the same as or similar to WTRU 102.

Additionally or alternatively, at step 5, if the AIoTF 382 does not receive service pattern information from the AIoT AF 390, the AIoTF 382 may invoke an NWDAF analytics service to obtain the service pattern information. For example, the AIoTF 382 may transmit a request, such as an Nnwdaf_AnalyticsInfo_Request, to the NWDAF 370. In an example, the AIoTF 382 may provide the AIoT service identifier (such as the fully qualified domain name (FQDN) of the AIoT service provider) as the input to the analytics service. In a further example, the analytics ID used in the analytics service may indicate that the desired analytics output is service pattern information.

Additionally or alternatively, at step 6, the AIoTF 382 may receive a response, such as an Nnwdaf_AnalyticsInfo_Request response, from the NWDAF 370. In an example, the Nnwdaf_AnalyticsInfo_Request response may include the service pattern information.

At step 7, the AIoTF 382 may transmit a service request to a the NG-RAN node 304. In an example, the service request may be an AIoT service request. In a further example, the service request may be received in an N2 message. For example, the service request may be an N2 AIoT service request. Additionally or alternatively, the AIoTF 382 forwards the AIoT service request to the NG-RAN(s), such as NG-RAN node 304, that serves the candidate WTRU Reader(s), in a N2 message. The AIoTF 302 can also provide the list of candidate WTRU Readers, target area and Service Pattern information in the N2 message.

At step 8, after receiving the N2 AIoT service request, the NG-RAN node 304 may further select or down-select the candidate WTRU Readers, for example, based on more precise location information or a mobility state of the candidate WTRU Readers. For example, if the NG-RAN node 304 is capable of AIML-based positioning calculation, it may collect the positioning measurements from the candidate WTRUs and feed the measurements to its AIML positioning model to obtain the precise locations of the candidate WTRUs.

At step 9, based on the received service pattern information and the content of the AIoT service request, the NG-RAN node 304 may determine the strategy for WTRU Reader state management, as described earlier. At step 10, the NG-RAN node 304 forwards the AIoT service request to the selected WTRU Reader(s), such as WTRU Reader 302, in a radio resource control (RRC) message. Additionally or alternatively, the AIoT service request in the RRC message includes the AIoT service request from the AIoT AF 390. For example, the AIoT service request in the RRC message includes the original AIoT service request.

Further, the WTRU reader 302 performs air interface AIoT service procedures. For example, at step 11, the WTRU reader 302 sends an AIoT paging/triggering message to the target AIoT device(s), such as AIoT device 340. Also, WTRU reader 302 receives an AIoT service response (e.g. inventory response) messages from the target AIoT device(s), such as AIoT device 340, at step 12. Additionally or alternatively, the AIoT service response is sent with, or as part of, an AIoT random access message.

At step 13, the WTRU reader 302 forwards the received AIoT service response messages to the NG-RAN node 304 in an RRC message. Further, at step 14, the NG-RAN node 304 forwards the AIoT service response messages to the AIoTF/AMF 382, which will further forward them to the AIoT AF or AIoT service provider that initiated the request. For example, the AIoTF/AMF 382 will forward the RRC AIoT service response messages to NEF 380. Additionally or alternatively, the AIoTF/AMF 382 will forward the RRC AIoT service response messages to AIoT AF 390. Additionally or alternatively, the NEF 380 will forward the RRC AIoT service response messages to AIoT AF 390.

Also, at step 15a, based on the WTRU Reader state management strategy (derived in Step 9), the NG-RAN node 304 may immediately release the WTRU Reader 302 to an IDLE state, for example, if the NG-RAN node 304 determines that there will be no subsequent request for a long time. For example, the NG-RAN node 304 may transmit an RRC release message to the WTRU Reader 302. Based on the RRC release message, the WTRU Reader 302 may enter IDLE state.

Additionally or alternatively, at step 15b, based on the WTRU Reader state management strategy (derived in Step 9), the NG-RAN node 304 may immediately release the WTRU Reader 302 to an RRC_Inactive state, for example, if the NG-RAN node 304 determines that there will be infrequent subsequent requests. In an example, NG-RAN node 304 may transmit an RRC release message with configuration information to the WTRU Reader 302. Based on the RRC release message, the WTRU Reader 302 may enter the RRC_Inactive state. Additionally or alternatively, the configuration information may include, or may indicate, information for the WTRU Reader 302 to resume an RRC connected state. Additionally or alternatively, the configuration information may be a suspendConfig information element (IE).

For example, NG-RAN node 304 may transmit an RRC release message with a suspendConfig IE to the WTRU Reader 302. Based on the suspendConfig IE in the RRC release message, the WTRU Reader 302 may enter the RRC_Inactive state.

Additionally or alternatively, after the NG-RAN node 304 forwards the AIoT service response messages to the AIoTF/AMF 382, the NG-RAN node 304 may keep the WTRU reader 302 in RRC connected mode or RRC connected state. Accordingly, the WTRU reader 302 may maintain communication with the NG-RAN node 304.

In an example, a network node receives a first service request. The first service request includes service pattern information and a second service request. The network node may be an NG-RAN node in an example. For example, the network node may a gNB. Further, the network node selects a WTRU reader from among one or more candidate WTRUs. Also, the network node determines a WTRU state management strategy based on the service pattern information and the second service request. Further, the network node transmits, to the selected WTRU reader, a third service request in a first RRC message. Also, the third service request is an AIoT service request and includes the second service request. Further, the network node receives, from the selected WTRU reader, an AIoT service response in a second RRC message.

Additionally or alternatively, the network node may forward the received AIoT service response to an AIoTF node. Further, the first service request is received from the AIoTF node. Additionally or alternatively, the network node may transmit, based on the determined WTRU state management strategy, a first RRC release message to the selected WTRU reader.

Additionally or alternatively, the network node may transmit, based on the determined WTRU state management strategy, a second RRC release message to the selected WTRU reader. Additionally or alternatively, the second RRC release message includes configuration information for entering an RRC_Inactive state. Additionally or alternatively, the second RRC release message includes configuration information for resuming an RRC connected state.

Additionally or alternatively, the first service request is received in an N2 message. Additionally or alternatively, the second service request is an AIoT service request originating at an AIoT AF. Additionally or alternatively, the AIoT service request originating at the AIoT AF includes one or more of: a target AIoT device identifier, an AIoT service type, and a target area.

Additionally or alternatively, the WTRU reader is selected based on location information of the one or more candidate WTRUs. Additionally or alternatively, the location information is determined based on an AIML-based positioning calculation using collected positioning measurements of the one or more candidate WTRUs.

Additionally or alternatively, the WTRU reader is selected based on a mobility state of the one or more candidate WTRUs. Additionally or alternatively, the first service request includes a list of the one or more candidate WTRUs, and a target area.

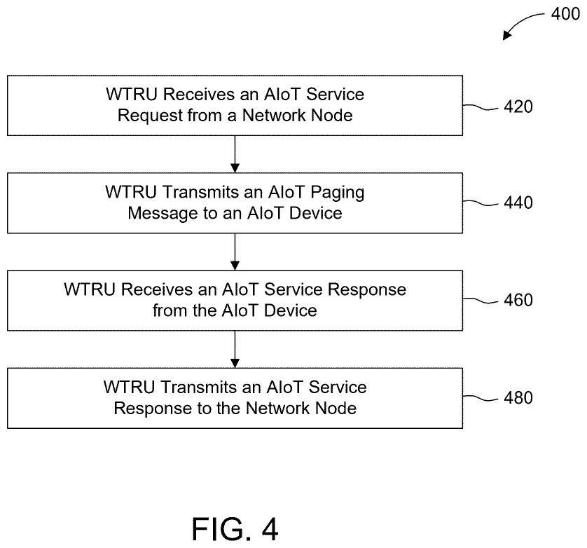

FIG. 4 is a flowchart diagram illustrating an example of a WTRU communication with an AIoT device concerning AIoT service. In an example shown in flowchart diagram 400, a WTRU receives an AIoT service request from a network node 420. Additionally or alternatively, the WTRU may be a WTRU reader. Additionally or alternatively, the network node may be an NG-RAN node in an example. For example, the network node may a gNB.

Further, the WTRU transmits an AIoT paging message to an AIoT device 440. Also, the WTRU receives a random access message from the AIoT device 460. Additionally or alternatively, the random access message may be an AIoT random access message. Additionally or alternatively, the random access message may include an AIoT service response.

Moreover, the WTRU may transmit an AIoT service response to the network node 480. In an example, the AIoT service response transmitted by the WTRU may be an RRC AIoT service response.

Examples are provided herein of service pattern information represented as a scalar value. For example, the service pattern information that is determined by the AIoTF and forwarded to the NG-RAN may be a scalar value that can be divided by an energy availability factor in order to obtain an estimate of the amount of time that the Reader WTRU needs to be kept in a CONNECTED state.

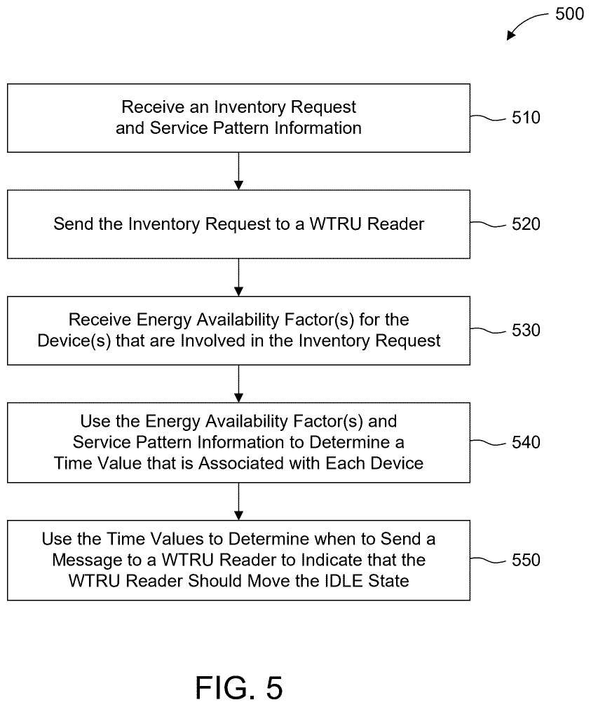

FIG. 5 is a flowchart diagram illustrating an example of how an NG-RAN node uses service pattern information. Examples in flowchart diagram 500 show how service pattern information may be used as a scalar value by an NG-RAN node. For example, the AIoT AF may determine the scalar value (for example, the service pattern information) based on the amount of data that the device(s) are expected to send in response to the Inventory Request. For example, a higher scalar value may be provided when the device is expected to reply with a large amount of data and a smaller scalar value may be provided when the device is expected to reply with a small amount of data.

The AIoTF may forward the service pattern information for the device(s) to the NG-RAN when the AIoTF sends the inventory request to a WTRU reader. The NG-RAN node receives the inventor request and service pattern information 510.

Further, the NG-RAN node may then send an inventory request to the WTRU reader 520. The WTRU reader may determine an energy availability factor for the device(s) that the WTRU needs to inventory. The WTRU reader may determine the energy availability factor based on any one of or on a combination of the following.

For example, the WTRU reader may determine the energy availability factor based on the types of devices that are being inventoried (e.g. it may be known that certain types of devices have a lot of energy available for transmitting). Further, the WTRU reader may determine the energy availability factor based on the location of the WTRU Reader and/or device(s) (e.g. it may be known that certain types of devices are able to harvest a lot of energy when in certain locations). Also, the WTRU reader may determine the energy availability factor based on the time of day (e.g. it may be known that certain types of devices are able to harvest a lot of energy at certain times of day). Moreover, the WTRU reader may determine the energy availability factor based on the information that is received from the device that indicates how much energy is stored in the device. Additionally or alternatively, the WTRU reader may determine the energy availability factor based on the information that is received from the device that indicates the rate at which the device is able to harvest energy.

The WTRU may send an acknowledgement message in response to the inventory request. The acknowledgment message may include an energy availability factor for each device that the WTRU Reader will attempt to inventory. Accordingly, the NG-RAN node may receive the energy availability factors for the devices that are involved in the inventory request 530.

Further, for each device that the WTRU Reader will attempt to inventory, the NG-RAN node may devise or determine the service pattern information scalar by using the energy availability factor for the device to obtain an estimate of how much time is likely to pass before the WTRU completes the inventory operation 540. In an example, the estimate of time is determined as a time value.

Moreover, the NG-RAN node may use one or more calculated time values to determine how to keep the WTRU in the CONNECTED state. For example, NG-RAN node may use the time value(s) to determine when to send a message to the WTRU to indicate that the WTRU should move an IDLE state 550.

Examples provided herein include the handling of WTRU reader mobility in an RRC inactive state. In an example, when the selected NG-RAN node (e.g., gNB-1) receives the candidate WTRU list and the AIoT request from the AIoTF/AMF, as described in Step 7 of FIG. 3, one or multiple candidate WTRUs may be in RRC_Inactive mode. In this case, the NG-RAN node will initiate RAN Paging in its serving area or a wider RAN-based Notification Area (RNA) that is served by other NG-RAN nodes. There may be two situations of RAN paging result, as further explained below.

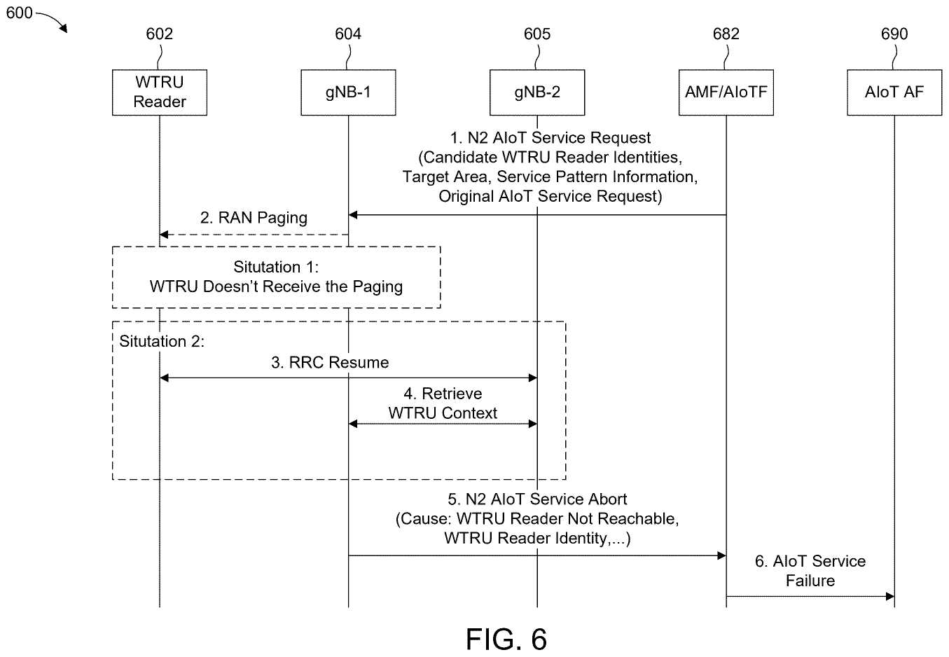

FIG. 6 is a signaling diagram illustrating an example of an AIoT service abort due to a not reachable WTRU reader. As shown in signaling diagram 600, in a situation 1, the paging is not received by the candidate WTRU, such as WTRU reader 602. In an example, this is because the WTRU reader 602 has moved out of the RNA.

In a situation 2, if the candidate WTRU reader 602 has moved to an area served by another NG-RAN node, for example, gNB-2 605, and received the RAN Paging, the WTRU reader 602 will resume its RRC connection and return to RRC_Connected state with the new NG-RAN node, such as gNB-2 605. The original selected NG-RAN node, such as gNB-1 604, is not able to complete the AIoT service procedure as the candidate WTRU Reader 602 is not reachable by this NG-RAN node.

If either of the situations occurs, the original selected NG-RAN node should inform the AIoTF that the candidate WTRU Reader is not reachable and the AIoT service request cannot be handled by the NG-RAN node. The NG-RAN node may provide the WTRU Reader identity, the timestamp and the paging area where the RAN Paging has been attempted, the new NG-RAN identity which the WTRU has resumed connection with, and so forth. Upon this report from the NG-RAN node, the AIoTF may select other candidate WTRU Readers that can serve the AIoT service request and re-attempt the procedure, or the AIoTF may abort the procedure and inform the AIoT service provider that the service request cannot be completed.

As shown in an example in FIG. 6, in step 1 gNB-1 604 receives an N2 AIoT service request from an AIoTF 682. The request may include the candidate WTRU Reader identities. Additionally or alternatively, the request may include the target area, service pattern information and the original AIoT service request.

At step 2, if the candidate WTRU 602 is in RRC_Inactive state, gNB-1 604 will initiate RAN paging to try to bring the candidate WTRU 602 back to Connected mode. In one situation, the candidate WTRU 602 may not receive the Paging if it has moved out of the RNA. In an example, this may be in situation 1. In another situation, the candidate WTRU 602 receives the Paging but it has moved to the cells of another gNB and will resume its connection with the new gNB, as described below. In an example, the new gNB may be gNB-2 605.

The candidate WTRU performs an RRC Resume procedure with gNB-2 605, at step 3. In an example, this may be in situation 2.

At step 4, the gNB-2 605 retrieves the WTRU context from gNB-1 604. As a result, gNB-1 604 is now aware that the candidate WTRU Reader is in control of another gNB.

Further, the gNB-1 604 sends an N2 AIoT Service Abort message to the AIoTF/AMF 682, at step 5. The message may indicate that the cause of the service procedure abort or failure is that the WTRU Reader 602 is not reachable. Further, the message may provide additional information such as WTRU Reader identity, gNB-2 identity, the timestamp and the paging area where the RAN Paging has been attempted, and the like.

At step 6, the AIoTF 682 may inform the AIoT service provider that the service request cannot be completed and provide the reason. In an example, the AIoT service provider may be an AIoT AF, such as AIoT AF 690.

Similarly, if the WTRU Reader's handover procedure is triggered before the AIoT service procedure is completed (e.g., before receiving the AIoT service response from the WTRU Reader), the NG-RAN should also send a AIoT service abort or failure report to the AIoTF, with a different cause such as WTRU handover or the like.

Examples provided herein include an AIoT service specific registration area. The AIoT service specific registration area may be used for mobility aspects.

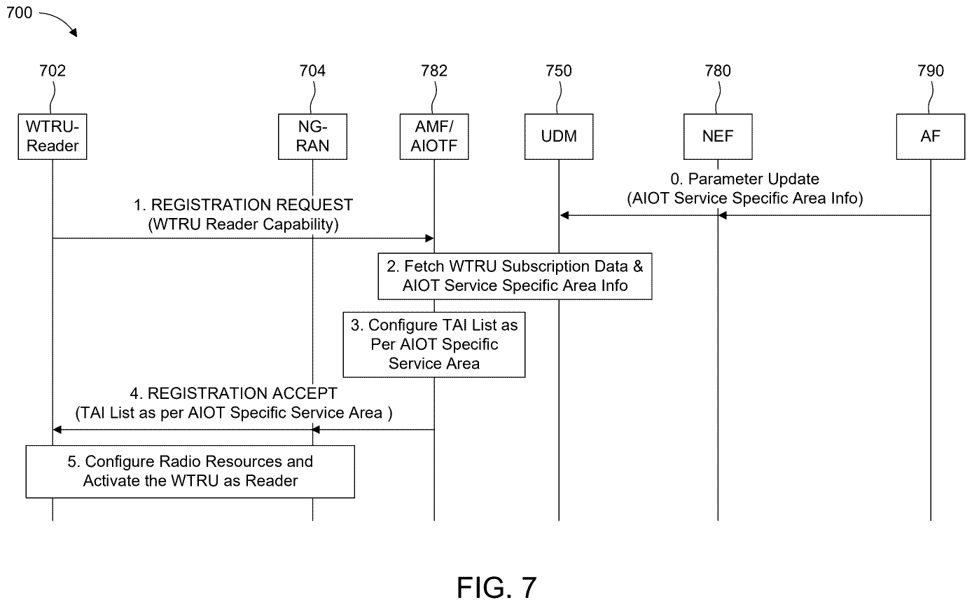

FIG. 7 is a signaling diagram illustrating an example of an AIoT service specific area configuration and usage. Signaling diagram 700 shows an example procedure of the configuration of the AIoT specific service area to a WTRU reader 702 and usage of this information by the WTRU reader 702 for mobility aspects.

In step 0, the AF 790 configures the UDM 750 via NEF 780 with an AIoT service specific area (AIoT SSA) information. An AIoT SSA refers to the area which covers specific AIoT service, for example, a large deployment of AIoT devices in an industrial setup could form a single AIoT Service specific area. For example, this information could be provided as a geofence location by the AF 790 and internally mapped by the NEF 780 to the TAI list.

Further, in step 1, during the registration procedure the WTRU provides its capabilities as a WTRU reader 702. For example, the WTRU reader 702 may transmit a registration request, including WTRU reader capability information, to an AMF/AIoTF 782.

In step 2, the AMF/AIoTF 782 obtains the WTRU subscription data and information about the AIoT SSA information from the UDM 750. For example, this information may be fetched from the UDM 750.

The AMF/AIoTF 782 takes into consideration the AIoT SSA to influence the configuration of the TAI list for the WTRU reader 702 in step 3. Additionally or alternatively, the AMF/AIoTF 782 could provide this information via a different NAS information element to the WTRU reader 702. This configuration of the TAI list influenced by the AIoT SSA is only applicable to the WTRU readers and is not applicable to normal WTRUs.

The TAI List/Registration Area determination by the AMF 782 considers the AIoT SSA, NG-RAN nodes which serve the AIoT SSA and connected AIoTF, mapping of the AIoT SSA to internal TAI list, and WTRU capabilities (e.g. WTRU is capable of being a WTRU reader). The configuration of the TAI list will ensure that mobility updates from the WTRU readers will provide accurate information to the AMF/AIoTF about the number of WTRU readers available in a specific AIoT SSA.

In step 4, a Registration Accept message is sent back to the WTRU reader 702 along with the TAI list information configured as per the AIoT SSA. For example, the AMF/AIoTF 782 send the registration accept message to the WTRU reader 702. Additionally or alternatively, the AMF/AIoTF 782 send the registration accept message to the NG-RAN node 704, which then forwards the registration accept message to the WTRU reader 702.

Mobility registration updates by the WTRU readers, such as WTRU reader 702, as per the configured TAI list will ensure that the AMF/AIoTF 782 is aware of the precise WTRU readers locations and number of the WTRU readers within the AIoT Service area. In an example, the number of the WTRU readers may be the number served by set of the NG-RAN nodes under a specific AIoT SSA. This information can be further used for selection of the WTRU readers for AIoT services, such as inventory/command requests.

In step 5, the NG-RAN node 704 activates the WTRU as an intermediate node/WTRU reader 702 and provides the radio configuration. In an example, the radio configuration may include a licensed frequency for communicating with AIoT devices.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a network node, the method comprising:
receiving a first service request, wherein the first service request includes service pattern information and a second service request;
selecting a wireless transmit/receive unit (WTRU) reader from among one or more candidate WTRUs;
determining a WTRU state management strategy based on the service pattern information and the second service request;
transmitting, to the selected WTRU reader, a third service request in a first radio resource control (RRC) message, wherein the third service request is an ambient-power-enabled Internet of things (AIoT) service request and includes the second service request; and
receiving, from the selected WTRU reader, an AIoT service response in a second RRC message.

2. The method of claim 1, further comprising:
forwarding the received AIoT service response to an AIoT function (AIoTF) node, wherein the first service request is received from the AIoTF node.

3. The method of claim 1, further comprising:
transmitting, based on the determined WTRU state management strategy, a first RRC release message to the selected WTRU reader.

4. The method of claim 1, further comprising:
transmitting, based on the determined WTRU state management strategy, a second RRC release message to the selected WTRU reader, wherein the second RRC release message includes configuration information for entering an RRC_Inactive state.

5. The method of claim 1, wherein the first service request is received in an N2 message.

6. The method of claim 1, wherein the second service request is an AIoT service request originating at an AIoT application function (AF), wherein the AIoT service request originating at the AIoT AF includes one or more of: a target AIoT device identifier, an AIoT service type, and a target area.

7. The method of claim 1, wherein the WTRU reader is selected based on location information of the one or more candidate WTRUs.

8. The method of claim 7, wherein the location information is determined based on an artificial intelligence machine learning (AIML)-based positioning calculation using collected positioning measurements of the one or more candidate WTRUs.

9. The method of claim 1, wherein the WTRU reader is selected based on a mobility state of the one or more candidate WTRUs.

10. The method of claim 1, wherein the first service request includes a list of the one or more candidate WTRUs, and a target area.

11. A network node comprising:
a transceiver; and
a processor, operatively coupled to the transceiver; wherein:
the transceiver and the processor are configured to receive a first service request, wherein the first service request includes service pattern information and a second service request;
the processor is configured to select a wireless transmit/receive unit (WTRU) reader from among one or more candidate WTRUs;
the processor is configured to determine a WTRU state management strategy based on the service pattern information and the second service request;
the transceiver and the processor are configured to transmit, to the selected WTRU reader, a third service request in a first radio resource control (RRC) message, wherein the third service request is an ambient-power-enabled Internet of things (AIoT) service request and includes the second service request; and
the transceiver and the processor are configured to receive, from the selected WTRU reader, an AIoT service response in a second RRC message.

12. The network node of claim 11, wherein:
the transceiver and the processor are further configured to forward the received AIoT service response to an AIoT function (AIoTF) node, wherein the first service request is received from the AIoTF node.

13. The network node of claim 11, wherein:
the transceiver and the processor are further configured to transmit, based on the determined WTRU state management strategy, a first RRC release message to the selected WTRU reader.

14. The network node of claim 11, wherein:
the transceiver and the processor are further configured to transmit, based on the determined WTRU state management strategy, a second RRC release message to the selected WTRU reader, wherein the second RRC release message includes configuration information for entering an RRC_Inactive state.

15. The network node of claim 11, wherein the first service request is received in an N2 message.

16. The network node of claim 11, wherein the second service request is an AIoT service request originating at an AIoT application function (AF), wherein the AIoT service request originating at the AIoT AF includes one or more of: a target AIoT device identifier, an AIoT service type, and a target area.

17. The network node of claim 11, wherein the WTRU reader is selected based on location information of the one or more candidate WTRUs.

18. The network node of claim 17, wherein the location information is determined based on an artificial intelligence machine learning (AIML)-based positioning calculation using collected positioning measurements of the one or more candidate WTRUs.

19. The network node of claim 11, wherein the WTRU reader is selected based on a mobility state of the one or more candidate WTRUs.

20. The network node of claim 11, wherein the first service request includes a list of the one or more candidate WTRUs, and a target area.
